(19) United States
(12) Patent Application Publication
(10) Pub. No.: US 2011/0126948 A1
(43) Pub. Date: Jun. 2, 2011

(54) REACTIVE PLANAR SUSPENSION FOR A WHEEL

(76) Inventors: Geoffrey Boyer, Dorval (CA); Raymond Paul Nicosia, Troy, MI (US); Arnir Khajepour, Waterloo (CA); Mohsen Azimi, Waterloo (CA)

(21) Appl. No.: 13/057,037

(22) PCT Filed: Jul. 31, 2009
(86) PCT No.: PCT/CA2009/001063

§ 371 Date: Feb. 1, 2011

Related U.S. Application Data
(60) Provisional application No. 61/085,706, filed on Aug. 1, 2008.

(51) Int. Cl. B60B 9/10; B60B 9/02; B60B 9/04

(52) U.S. Cl. 152/40; 152/17; 152/76

(57) ABSTRACT

There is described a suspension wheel comprising a substantially rigid rim, a substantially rigid hub disposed concentrically within the rim to define an annular space between the rim and the hub, the hub being adapted for connection to an axle for the wheel, and suspension members disposed in the annular space and connected to the rim and the hub to allow the rim to move in one or both of the horizontal and vertical directions relative to the hub in response to an input to the rim.

### FIELD OF THE INVENTION

The present invention relates generally to a suspension system embedded in the wheel of a vehicle or wheeled device such as a bicycle, automobile, wheelchair, hand truck, cart or the like and more particularly to a suspension that resiliently suspends the wheel's axle for any path of independent movement of the wheel relative to the axle in both the X and Z plane within the suspension's limits.

### BACKGROUND OF THE INVENTION

For any road vehicle, a common method used to isolate undesirable effects of shocks and vibrations is the use of a suspension system. Suspension systems have been traditionally utilized on different types of vehicles, such as motorcycles, passenger cars, trucks and bikes. A suspension is basically a system of a spring and damper that is used to reduce the transferred vibrations to a vehicle's chassis. The spring element can be a coil spring, leaf spring or a torsion bar. The damper element is usually a shock absorber or rubber. Different forms of suspension systems have been adapted to passenger vehicles, for example, McPherson, double wishbone and multi-link suspensions. Two wheeled vehicles typically use forks which can incorporate shock absorbers and/or springs. In addition to the suspension system, the stiffness and damping properties of tires, which are usually pneumatic, help to partially alleviate the effects of shocks and vibrations. The construction and configuration of suspension systems have remained almost unchanged in the past century. Current suspension systems provide only one isolation direction to attenuate shock forces and disturbances. However, in many situations, isolation in more than one direction can improve safety and comfort significantly. For instance, in wheelchairs, bicycles and motorcycles, injuries and deaths resulting from tipping over upon hitting an obstacle are very common. The addition of a planar suspension system capable of reacting to any direction of force could reduce deaths and injuries considerably. Also the existing suspension systems usually take up a significant amount of space that might otherwise be used for passenger comfort, subsystem design modification, or reduction in overall size and weight of the vehicle. For instance, exhaust pipes, brake and fuel systems lines must be made with complicated shapes due to the confined space under the vehicle. Moreover, the existing suspension systems are difficult to access, making maintenance and repair difficult. In addition, they are relatively heavy and complex, leading to a negative effect on the vehicle fuel economy. Finally, the use of pneumatic tires, which is essential in existing suspension systems, results in more rolling resistance thus deteriorating vehicle fuel efficiency. Pneumatic tires also suffer single point failure which is an obvious safety issue.

Vehicle suspensions serve to isolate and/or reduce the forces transmitted to the chassis, frame, and/or occupant. All vehicle suspensions to date use some sort of fixed linear and/or fixed planar travel path. This includes suspensions directly or indirectly coupled to a spring and/or dampener, suspensions directly or indirectly coupled to a frame, and/or chassis, and passive and/or adaptive suspensions. In other words, when a conventional vehicle suspension is compressed or exercised, due to a wheel of the vehicle impacting an obstacle, the wheel of the vehicle always travels along the same path. For purposes of this description, the path that the wheel follows during suspension movement is called the ‘travel path’.

However, it is rare that a vehicle only encounters one impact or simple disturbance when traversing an obstacle or “input”. Rather, a wheel is likely to encounter a series of disturbances like those encountered on a rough road. The problem with prior art suspensions is that they do not effectively absorb loads resulting from such impacts. Typically, when a vehicle impacts an obstacle, the orientation of the impact force changes throughout the vehicle suspension's travel path and therefore only a small portion of the travel is truly effective to absorb the impact's energy. Ideally, a truly effective suspension provides a vehicle frame and/or chassis with an ideal path to absorb a load under dynamic disturbance, and the suspension would further dissipate that load in a manner which would provide the occupant in the vehicle a more comfortable, stable platform.

### SUMMARY OF THE INVENTION

Accordingly, it is an object of the present invention to provide an improved reactive suspension system that obviates and mitigates from the disadvantages and limitations of the prior art.

One objective of the present invention is to provide a suspension with a reactive travel path that can move with no more than three degrees of freedom.

Another objective of the present invention is to provide a suspension which can be incorporated within or adjacent to one or more wheels of a vehicle.

Another objective of the present invention is to provide a suspension system which can absorb more of a vehicle's load disturbances than conventional suspension systems combinations are able to absorb.

Another objective in a preferred embodiment of the present invention is to provide a suspension system which allows a vehicle to use a harder tire with a lower profile or even eliminates the use of a pneumatic tire altogether without sacrificing comfort or performance.

Yet another objective in a preferred embodiment of the present invention is to provide a suspension that reduces the unsprung mass of a vehicle.

One or more of the stated objectives is accomplished by a novel suspension system for any type of ground, air, space or marine vehicle or conveyance. The suspension is a system wherein, during suspension movement, a vehicle wheel is allowed to travel relative to an axle in a reactive travel path with at least two or in some cases, three degrees of freedom. This reactive travel path distinguishes the present invention from the fixed linear or fixed planar travel paths of the prior art suspensions.

The present suspension has significant advantages over prior art suspensions. While conventional suspensions restrict a vehicle's wheel to a fixed travel path, the current suspension allows the vehicle's wheel to travel any two-dimensional path relative to the axle. The wheel travel path of the current suspension is determined by the input, i.e. for any given input, the suspension responds instantaneously or near instantaneously and opposite to the input with a wheel travel path that best responds to the input.

Since a vehicle's axle is not restricted to a defined travel path, like fixed linear or fixed planar suspensions, the current suspension can react to a new input at any point of a travel path and create a new reactive travel path. Additionally, since the recovery travel of the suspension is not tied to the impact path, the suspension can recover faster than prior art suspensions.

The current suspension can be embedded in a wheel of any type, thereby packaging the suspension inside the wheel. When the suspension is embedded within a vehicle's wheel, the unsprung mass of the vehicle is reduced because only the mass of the wheel is unsprung mass. Its also possible to embed the current suspension however in some applications adjacent the wheel.

According to the present invention then, there is provided a suspension for a wheel rotatably mounted about an axle, comprising means to resiliently support said axle from movement in the X and Z planes of said wheel in response to an input to said wheel.

According to the present invention then, this is provided a suspension wheel comprising: a substantially rigid rim; a substantially rigid hub disposed concentrically within said rim to define an annular space between the rim and the hub, said hub being adapted for connection to an axle for said wheel; and suspension means disposed in said annular space and connected to said rim and said hub to allow said rim to move in one or both of the horizontal and vertical directions relative to said hub in response to an input to said rim.

According to another aspect of the present invention, there is provided a method of forming a suspension wheel comprising the steps of: disposing a substantially rigid wheel hub concentrically within a substantially rigid wheel rim to define an annular space therebetween; connecting the hub to the rim using a suspension means that allows the rim to move in one or both of the vertical and horizontal directions relative to the hub in response to an input to the rim.

### BRIEF DESCRIPTION OF THE DRAWINGS

Preferred embodiments of the present invention will now be described in greater detail and will be better understood when read in conjunction with the following drawings in which:

FIG. 1 is schematical representation of a wheel mounted in a conventional suspension;

FIG. 2 is a schematical representation of a suspension in accordance with one aspect of the present invention;

FIG. 3 is a schematical illustration comparing the travel path of a conventional suspension to a possible travel path of the present suspension;

FIG. 4 is a perspective view of a wheel having a suspension in accordance with another aspect of the present invention;

FIG. 5 is a perspective view of a wheel with revolute joints;

FIG. 6 is a perspective cross-sectional view of the wheel of FIG. 5 with protective plates;

FIG. 7 is an elevational view of another embodiment of the present wheel;

FIG. 8 is an elevational view of the wheel of FIG. 7 with additional detail;

FIG. 9 is an enlarged perspective view showing the connection between a spring and a rim of the wheel shown in FIG. 8;

FIG. 10 is an enlarged perspective view of a portion of the wheel showing a modified joint between the spring and rim;

FIG. 11 is an elevational view of another embodiment of the present wheel with a modified spring joint;

FIG. 12 is a side elevational view of the wheel with bumper stops;

FIG. 13 is a side elevational view of the wheel using struts for dampening;

FIG. 14 is a side elevational view of a wheel with alternative dampening;

FIG. 15 is a perspective, cross-section view of a wheel showing another alternative means of dampening;

FIG. 16 is a side-elevational view of a wheel showing alternative means of dampening;

FIG. 17 is a elevational view of a wheel showing alternative spring means;

FIG. 18 is a perspective view of a wheel showing another alternative means of suspending the hub;

FIG. 19 is a cross-sectional view of the wheel of FIG. 17;

FIG. 20 is a side-elevational view of an alternative spring member for use in the wheel;

FIG. 21 is a side-elevational view of another embodiment of the present reactive planar suspension wheel for use on powered vehicles;

FIG. 22 is a side-elevational view of the wheel of FIG. 20 with re-oriented cross-numbers;

FIG. 23 is a perspective of a modification to the wheel of FIG. 19;

FIG. 24 is a perspective exploded view of the wheel of FIG. 20;

FIG. 25 is a cross-sectional view of the wheel of FIG. 21;

FIG. 26 is a side elevational view of a leaf spring for use on the RPS wheel of the present invention;

FIG. 27 is a perspective view of an alternative leaf spring configuration;

FIG. 28 is a perspective view of an alternative leaf spring configuration;

FIG. 29 is a perspective view of an alternative leaf spring configuration; and

FIG. 30 is a perspective view of an alternative leaf spring configuration;

### DETAILED DESCRIPTION OF THE PREFERRED EMBODIMENTS

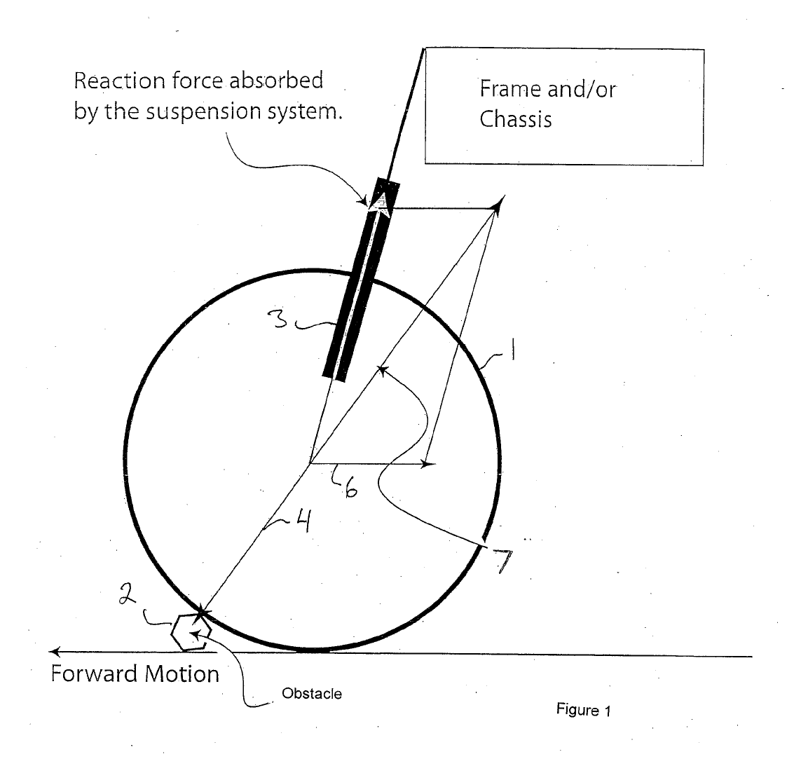

With reference to FIG. 1, this is a schematical representation of the limitations of current suspensions. Current suspensions are not fully effective at absorbing all of the energy encountered by a wheel contacting an obstacle. As can be seen in the Figure, a wheel 1 encountering an input in the nature of obstruction 2 can move only in the fixed linear or fixed planer path permitted by the suspension. Accordingly, while some of the energy from the impact is absorbed by the suspension's spring and damping mechanism, such as springs and shock absorbers 3, or a combination thereof, a vectored component 7 of the energy is transferred directly to the chassis along the impact's reaction line 4. This is one reason that sharp elevated bumps in the road can feel so jarring compared to relatively larger holes or depressions in the road which deflect the wheel more conformingly in its fixed linear or planer path of travel so that the reaction line is more directly into the shock absorber 3.

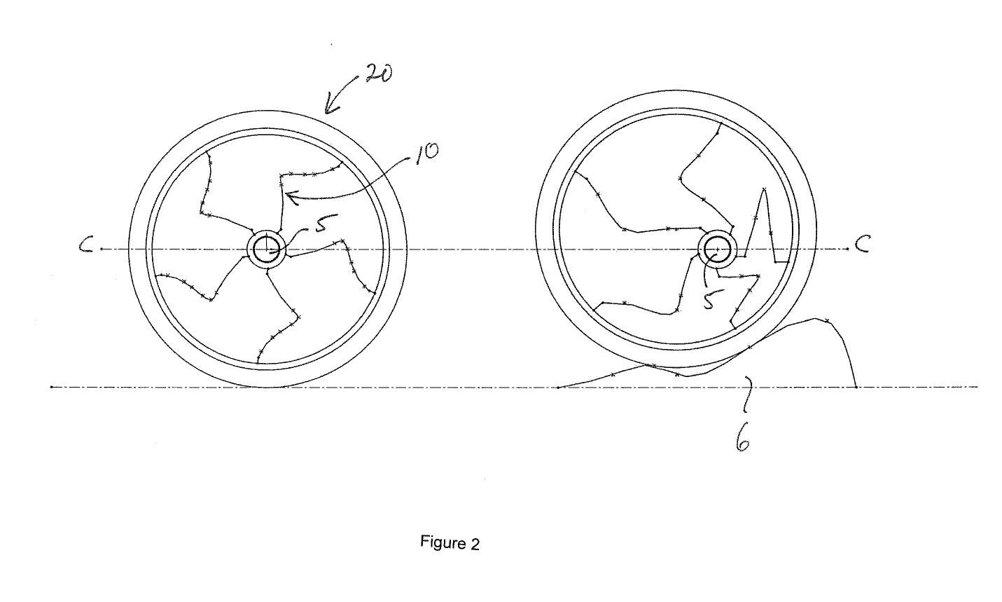

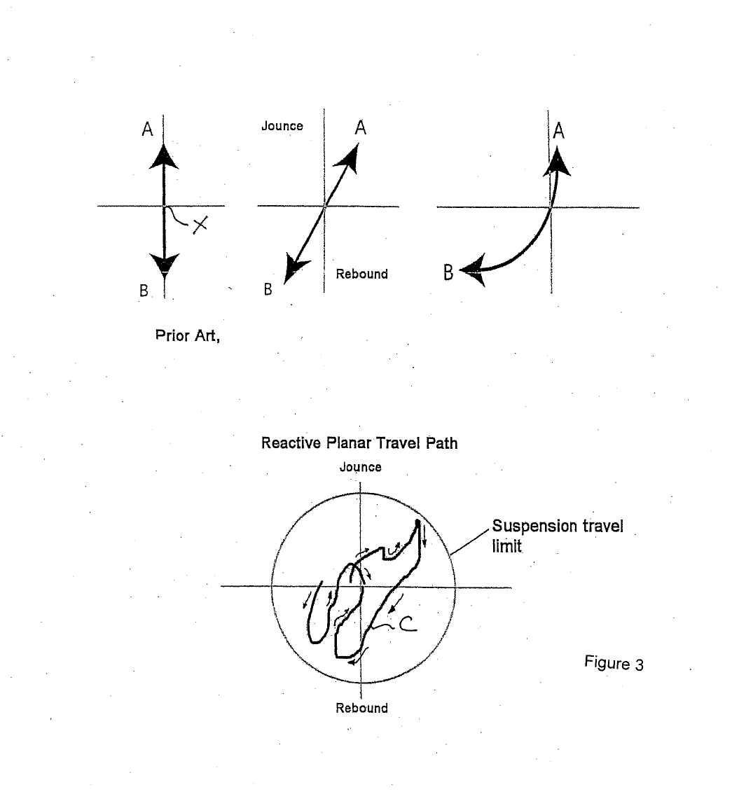

Ideally therefore, rather than a suspension that has a single or fixed path, it is preferable that the path of suspension travel when reacting to an input is the path that will best absorb the input's energy. So instead of the predetermined path of travel in a conventional system, the present reactive suspension proposes that its path of travel is actually determined by the input. This reaction is shown schematically in FIG. 2 showing a wheel 20 having a reactive planar suspension 10 where the wheel's axle 5 is resiliently supported relative to the wheel itself such as by means of springs 12. Accordingly, upon the impact of the wheel with the input 6, the wheel can displace itself, relatively speaking, away from the input along or nearly along a reactive line for more direct absorption of the input's energy and a more comfortable, stable ride for the vehicle's occupant due to axle 5's stable horizontal equilibrium along the line C-C. The wheel's ability to react to the input in both the X and Z planes of the wheel allow the suspension to react dynamically as the orientation of the reaction line changes as the wheel traverses the input. This is shown most clearly in FIG. 3 which compares the fixed linear or planer path of travel A-B of a conventionally suspended axle, which must pass through its zero load position X as it moves up (jounce) and down (rebound), and the reactive travel path C of the present suspension which allows the axle to travel any path within the suspension's travel limits. In the present suspension therefore, the axle's travel can start from any position within the travel limits and is not required or restrained to travel through the zero load position X.

The zero load position of a conventional suspension is defined as the position of the suspension under static conditions when supporting the design load only.

Ideally, in the suspension of the present invention, the axle will remain relatively vertically stationary with wheel 20 and suspension 10 moving in reaction to the obstacle. There will obviously be some deflection of the axle as the input forces balance at the axle but it will be restrained.

Common to all reactive planar suspensions (RPS) in accordance with the present invention will be a rigid or substantially rigid outer rim, which may or may not be fitted or covered with a tire or other traction inducing means or material, a rigid or substantially rigid hub for connection to an axle and resiliently flexible members, such as leaf springs, connected between the rim and the hub. There can be structural differences between the flexible members depending upon whether the wheel is powered or non-powered.

Non-powered generally refers to vehicles that are pushed or pulled such as, without limitation, hand trucks, dollies, wagons, wheel barrows and the like. Powered vehicles are generally considered to be those vehicles which incorporate means to deliver torque to the wheels's axle to cause rotation. Examples include, without limitation, the likes of bicycles, motorcycles, automobiles, golf carts and so forth.

In non-powered wheels, the suspension of the present invention will allow no more than three degrees of freedom of movement. These degrees of freedom include vertical and horizontal displacement of the rim relative to the hub and a limited degree of rotation of the hub and rim relative to one another.

In powered wheels, the suspension of the present invention will allow only two degrees of freedom of movement, being vertical and horizontal displacement of the hub and rim relative to one another. Rotation of the hub and wheel relative to one another is restrained to avoid “wind-up” so that the application of either braking or driving torque is substantially instantaneous.

Both powered and non-powered wheels require infinite or near infinite rotational stiffness to prevent massive random or unbalanced movement or fluctuations of the wheel relative to the axle. In other words, to prevent the wheel from wobbling.

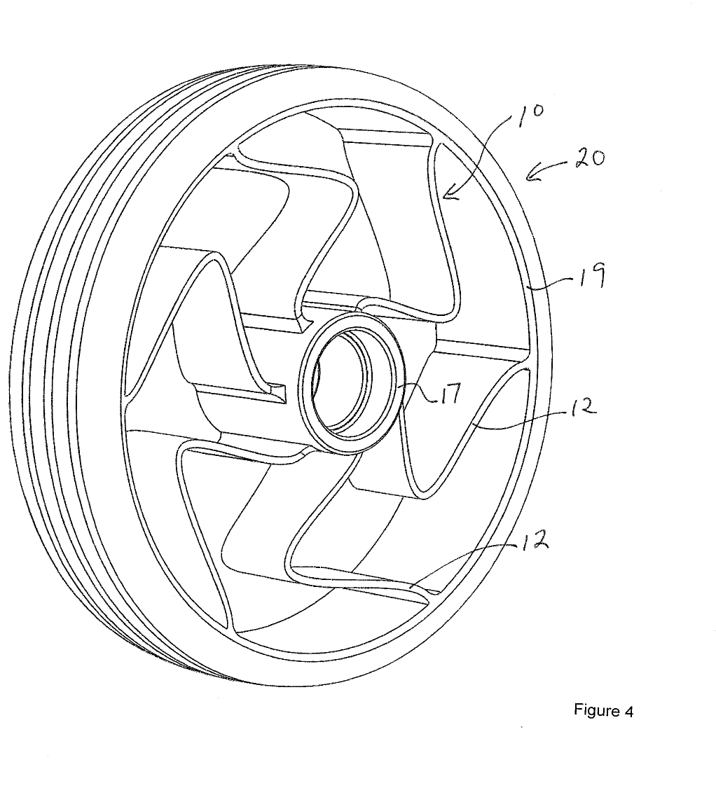

Reference will now be made to FIG. 4 showing a non-powered wheel 20 having a reactive planar suspension 10.

Wheel 20 comprises an outer rigid rim 19, and inner rigid concentric hub 17 and the reactive planar suspension system 10 disposed in the space between rim 19 and hub 17. The suspension system 10 rotates with the wheel and is a flexible structure that provides up to three degrees of freedom of movement, being vertical and horizontal displacement of rim 19 and hub 17 relative to one another and, possibly, some limited rotation of the hub relative to the rim. The vertical and horizontal displacement are possible because of the flexibility of suspension 10. The suspension is designed to not only allow the desired wheel travel but to also deliver the required stiffness and, if needed, damping.

In the embodiment shown in FIG. 4, suspension 10 comprises a plurality of radially spaced apart, generally “V”-shaped leaf springs 12 manufactured from a suitable material that provides sufficient strength, stiffness and resiliency. These materials can include but are not limited to plastic, metal, fibreglass and wood. The stresses in the springs should not exceed a predetermined amount depending upon the used material, the number of springs and expected life span of the wheel. In one embodiment constructed by the applicant, springs 12 have been manufactured from Delrin™ from Dupont Chemical Company. For any given use and/or loading of a wheel, testing will be necessary to determine optimal spring construction and stiffness. By way of example only, in a 10 inch diameter wheel intended for use on a hand truck, the wheel having a 2 inch diameter hub, with the truck having a maximum anticipated load of 500 lbf., the stiffness of each spring 12 will be 130 to 140 N/mm for 17 mm of suspension travel. In any given application of the wheel, the number of springs may vary but three to nine springs would normally be used.

In the embodiment shown, the inner and outer ends of each spring 12 are rigidly connected to rim 19 and hub 17 to form a non-revolute joint. It is possible therefor to manufacture this entire wheel, less any tire or tread, as a single one shot injection molded piece. As will be appreciated, the points where the springs connect to the rim and hub are subject to considerable stress and are therefore vulnerable to failure if subjected to heavy loads, so this design is best suited to light duties only.

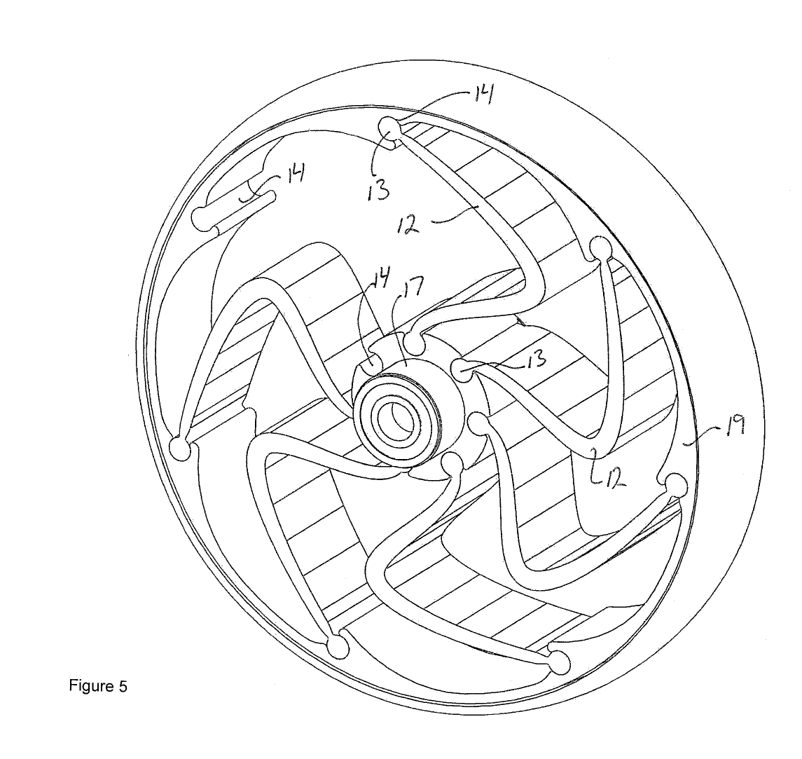

For heavier duty applications, it's preferable that the joints between the springs and the rim and hub be revolute, meaning that the joint provides for relative rotation between the ends of the springs and the hub and rim. An example of a revolute joint is shown in FIG. 5 wherein like elements are identified by like numerals.

In this embodiment, the ends of springs 12 are formed with a transversely extending cylindrical beads 13 that are slidingly received into correspondingly shaped sockets 14 formed on the opposing surfaces of the hub and rim as shown.

As will be appreciated, this construction substantially alleviates stress at the connection points of the springs to the hub and rim. However, if devices employing this construction are used in dirty or hostile environments, dirt, debris, and moisture entering the joints will cause wear and considerable friction, ultimately impairing performance and leading to eventual failure.

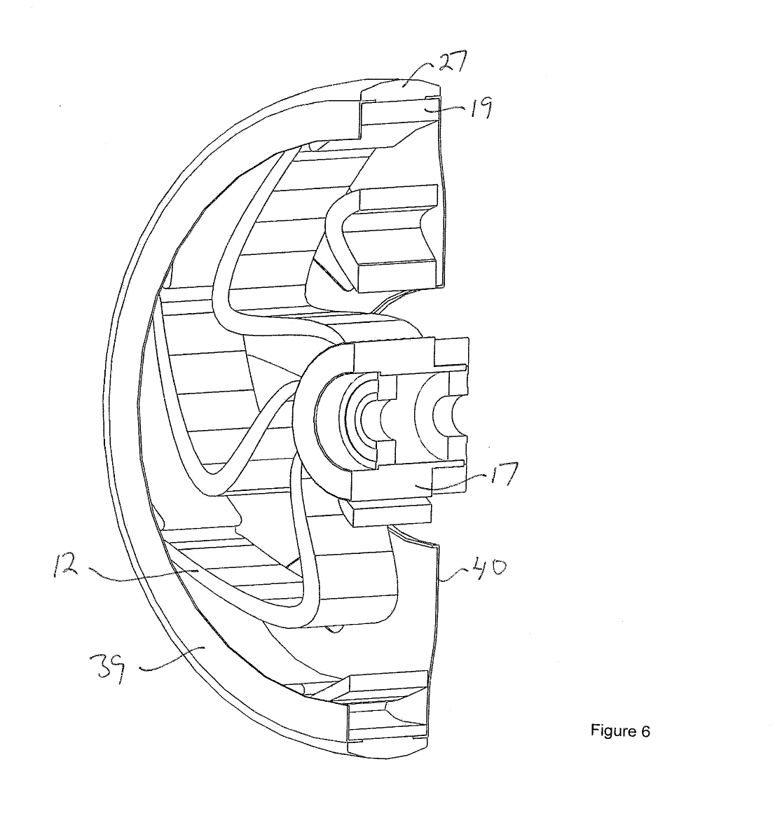

One way of alleviating this possibility is as shown in FIG. 6, which is to add protective plates or rings 39 and/or 40 to the outside edges of the rim and hub, or both, to limit ingress of dirt and debris. These plates or rings also retain beads 13 within sockets 14. This solution imposes its own limitations however in terms of limited effectiveness, and added weight and cost.

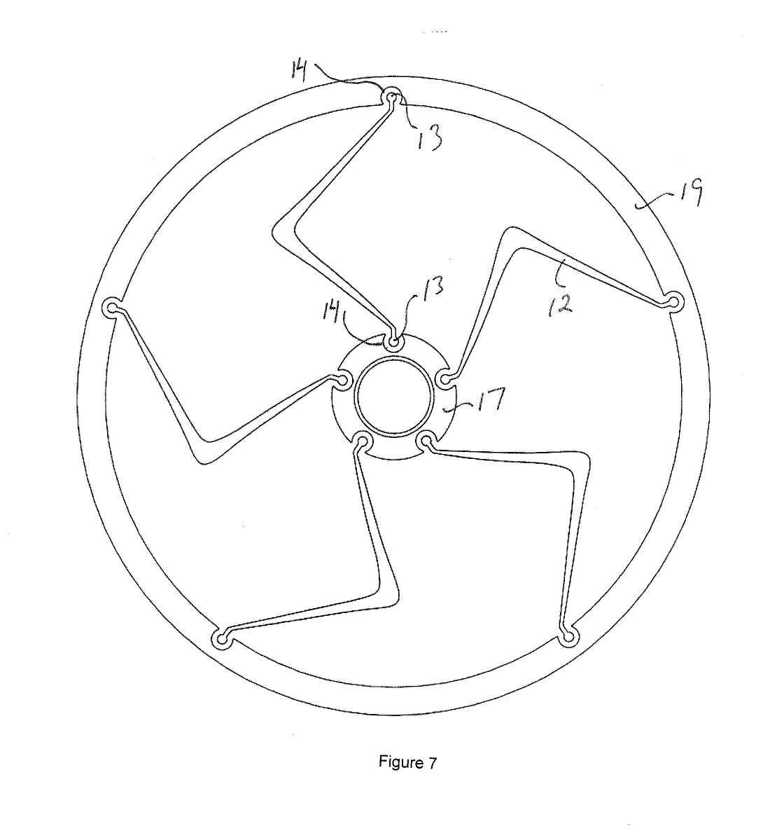

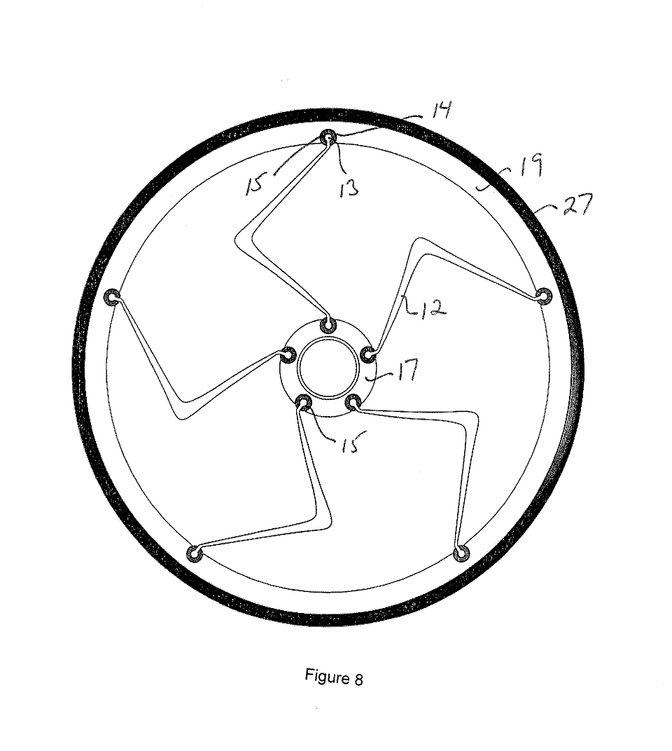

Another alternative therefore is to provide a semi-revolute joint between the springs and the rim/hub. Reference will now be made to FIGS. 7 and 8 showing a semi-revolute construction and wherein like elements are identified using like reference numerals. The wheel shown in FIGS. 7 and 8 can be manufactured in a number of different ways, but the “two shot” injection molding process, which is known in the art and which will not therefore be described in great detail herein, is particularly advantageous for this application.

With reference to FIG. 7, the first “shot” is to mold rim 19, hub 17 and springs 12 using a suitable material, such as Delrin™. After the first shot, the beads 13 at the ends of leaf springs 12 are “floating” inside the sockets 14 in rim 19 and hub 17. The mold is then turned 180 degrees, and a second layer of plastic or elastic material is molded over the first layer. More specifically, the annulus between each bead 13 and socket 14 is filled with elastic material to form a resilient sleeve 15 around beads 13.

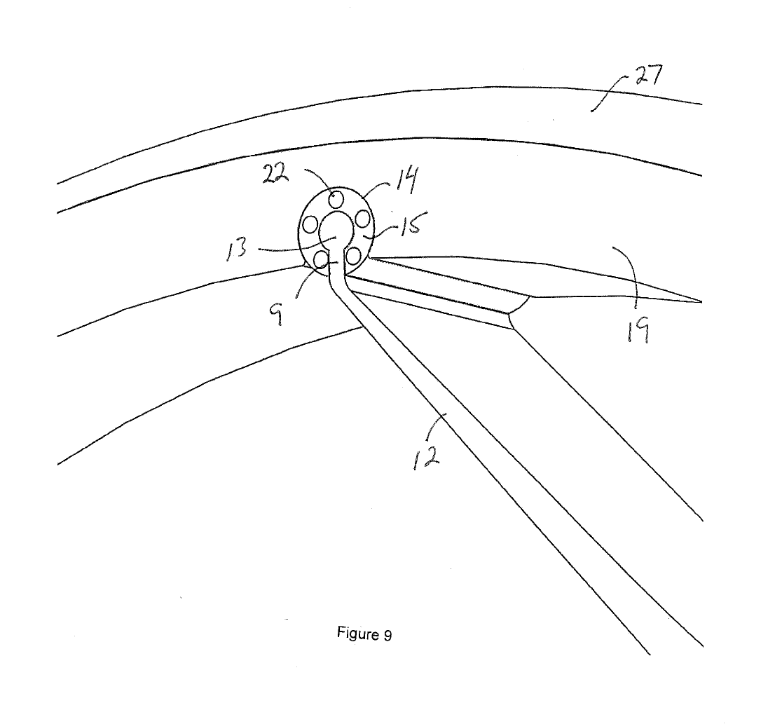

Sleeves 15 perform a number of different functions. They physically retain beads 13 in sockets 14 to prevent separation, they allow rotation of the beads relative to the rim and hub to relieve stress at the pivot points and they prevent the ingress of dirt, debris and moisture into the sockets. The sleeves are preferably cylindrical in cross-section shape and are formed slightly proud of the inner surface of the hub and rim as shown most clearly in FIG. 9 to provide additional support around the end portions 9 of springs 12. As also seen most clearly in FIG. 9, sleeves 15 can be formed with longitudinally extending voids 22 to allow easier rotation of beads 13 within sockets 14.

The material used to form sleeves 15 is preferably a resilient elastic material such as rubber, thermoplastic elastomer, polyurethane or other resilient material.

Shown in FIGS. 7 to 9, a layer or tread 28 of the elastic material can be molded or otherwise formed or fitted onto the outer surface of rim 19 for enhanced frictional contact with the ground and to provide a smoother feel to the rolling motion of the wheel when in use.

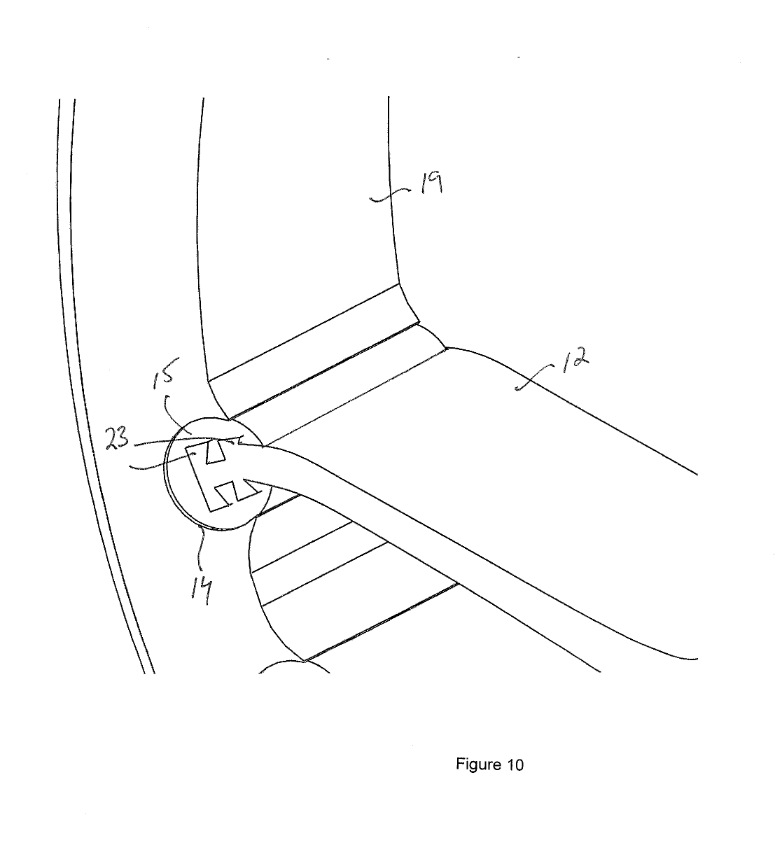

Although separation of beads 13 from sleeves 15 is unlikely, the possibility of separation can be reduced by providing a mechanical interlock and/or a chemical, covalent or adhesive bond between the springs and the sleeves. An example of a mechanical interlock is shown in FIG. 10 wherein the ends of springs 12 are formed into barbs 23 that physically embed within the sleeve to prevent separation. Careful selection of compatible materials will provide for covalent, chemical or adhesive bonding between the beads and sleeves.

Another non-revolute joint is shown in FIG. 11 in which like numerals have been used to identify like elements. Each of hub 17 and rim 19 are fitted with a required number of T-receivers 28 which include the female portion 31 of a dovetail joint. The ends of springs 12 are formed with the male portion 32 of the joint. This combination, although non-revolute, nevertheless provides for relaxed rotation of spring 12 relative to the hub and rim to alleviate stress at the pivot points.

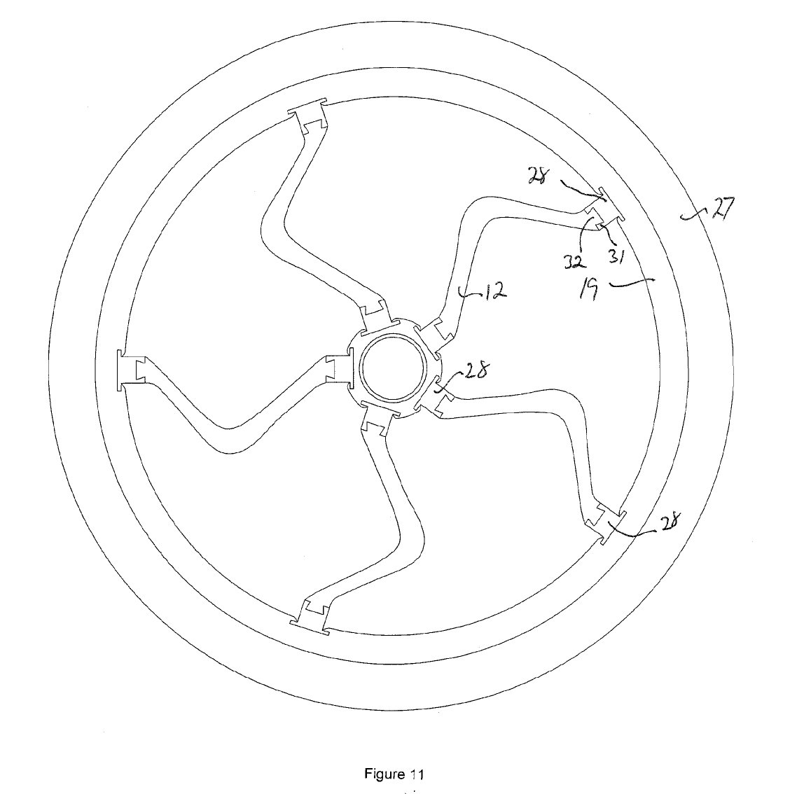

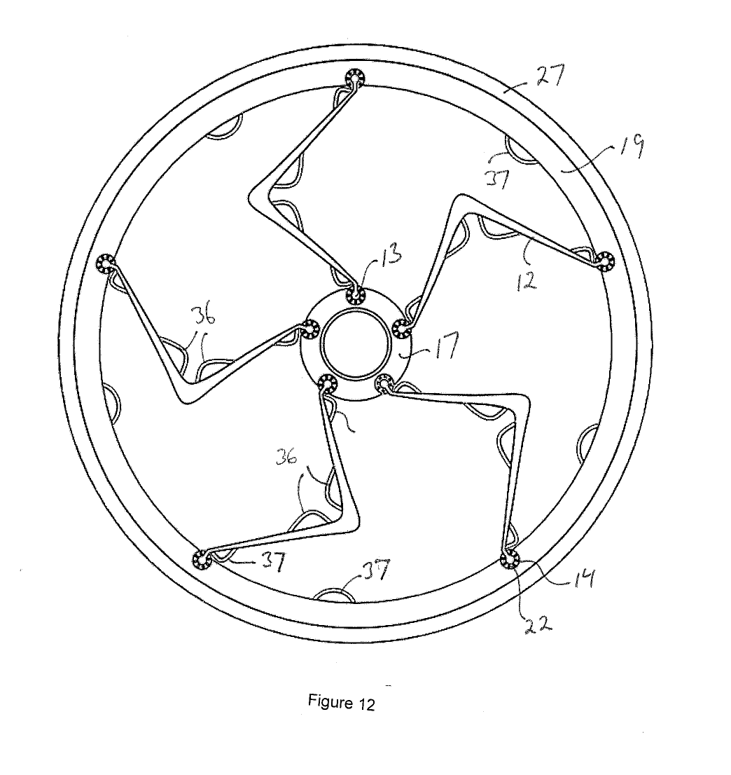

If it is expected that the wheel will be subjected to particularly heavy loads or rough surfaces which could excessively compress or tense springs 12, the wheel can be provided with progressive rate build up springs 36 and bump stops 37 as shown in FIG. 12. The arrangement of bump stops shown in this Figure is exemplary and other arrangements will occur to those skilled in the art.

Progressive rate build up springs 36 act in series with springs 12 to progressively increase the spring rates of springs 12. By way of example, if the nominal spring rate of spring 12 is 100 N/mm, and its desired that the spring rate increases with increasing load, build up springs 36 can be selected to progressively act in series as they compressively contact one another to increase the total spring rate to, for example, 140 N/mm. This can be particularly useful in the case of instantaneous loads or disturbances such as might occur when rolling off a curb or step which induces an anomolously large impact or disturbance.

In any suspension system, in addition to stiffness, damping is required to remove vibratory and/or residual energy out of the system. Conventional suspension systems typically use shock-absorbers to dampen vibration energy, and in RPS suspensions, it would be possible to add one or more shock-absorbers 42 as shown in FIG. 13 between hub 17 and rim 19. However, in view of weight, cost, structural, loading, balance and other considerations, this is not considered an optimal arrangement for RPS.

Sleeves 15 in the semi-revolude joints described above, due to their elastic nature, will provide some damping on their own.

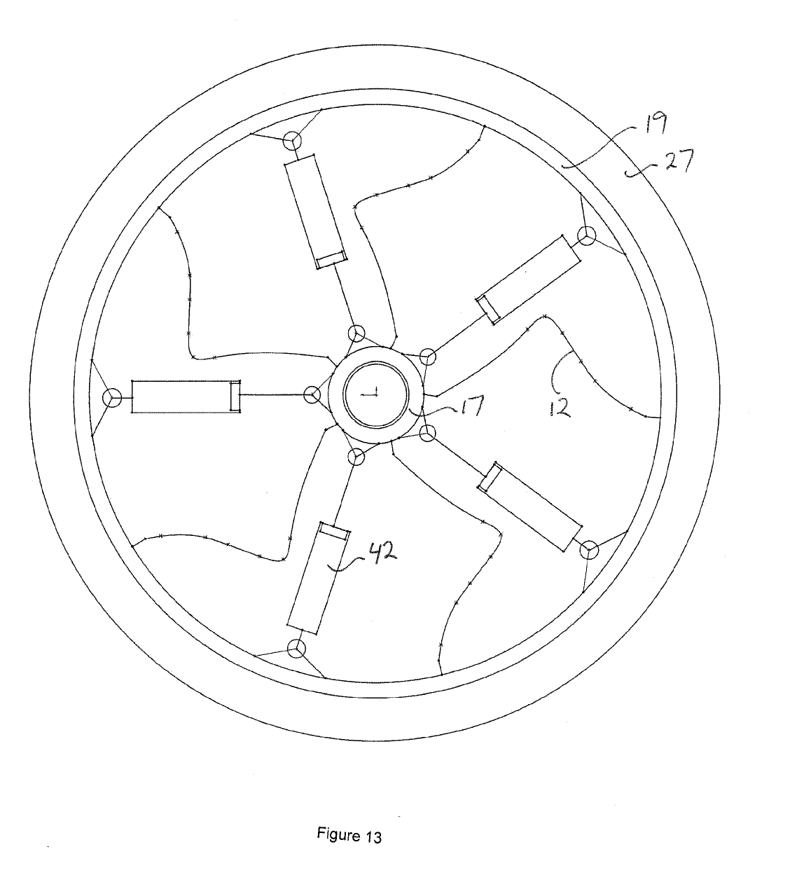

More optimally however, damping will be provided by coating, laminating or injecting rubber or a similar damping material onto or into the members that make up suspension 10. There are numerous alternatives in how to do this, some of which are shown in FIGS. 14 to 16. In FIG. 14, a rubber damper 44 is laminated onto each spring 12. In this embodiment, another bump stop mechanism is also shown consisting of a series of T-shaped bump stops 45 attached to spring 12 and embedded in the rubber at a predetermined distance apart from each other. At optimum flexure, the heads of the T′s interfere with one another to prevent or at least impede further movement of springs 12.

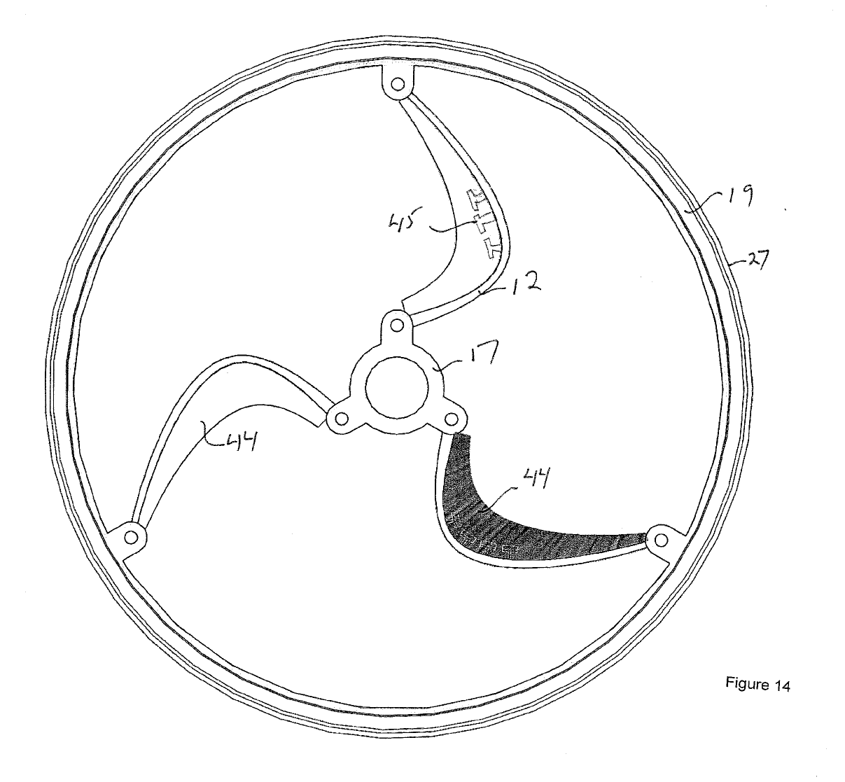

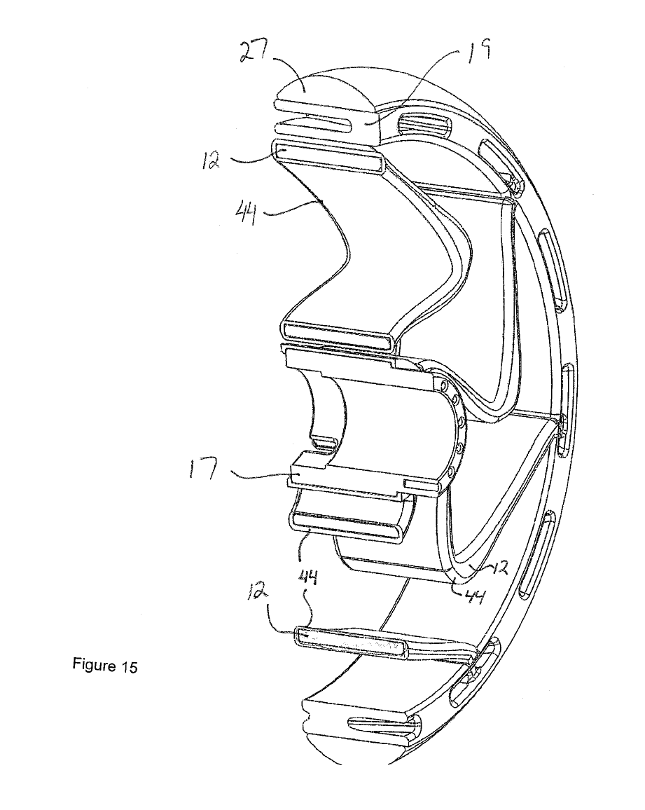

In FIGS. 15 and 16, springs 12 are coated or laminated or overmolded with rubber or elastomer 44.

In FIG. 12, build up springs 36 located on springs 12, if made of rubber, can provide some damping themselves.

These are but several examples of possible damping mechanisms, and others will occur to those skilled in the art familiar with the teachings of this specification.

Reference has been made above to the use of leaf-springs as the stiffening members of suspension 10. Leaf-springs are considered advantageous in view of their simple and light weight structure, the ability to optimize their size and stiffness for a given application, their versatility and the fact that their spring rates are consistent or fairly consistent through all 360 degrees of a wheel's rotation. They can also be mass manufactured in a prismatic geometry and are inherently stiff to prevent twisting. This is important because twisting would be an undesirable fourth degree of freedom of movement.

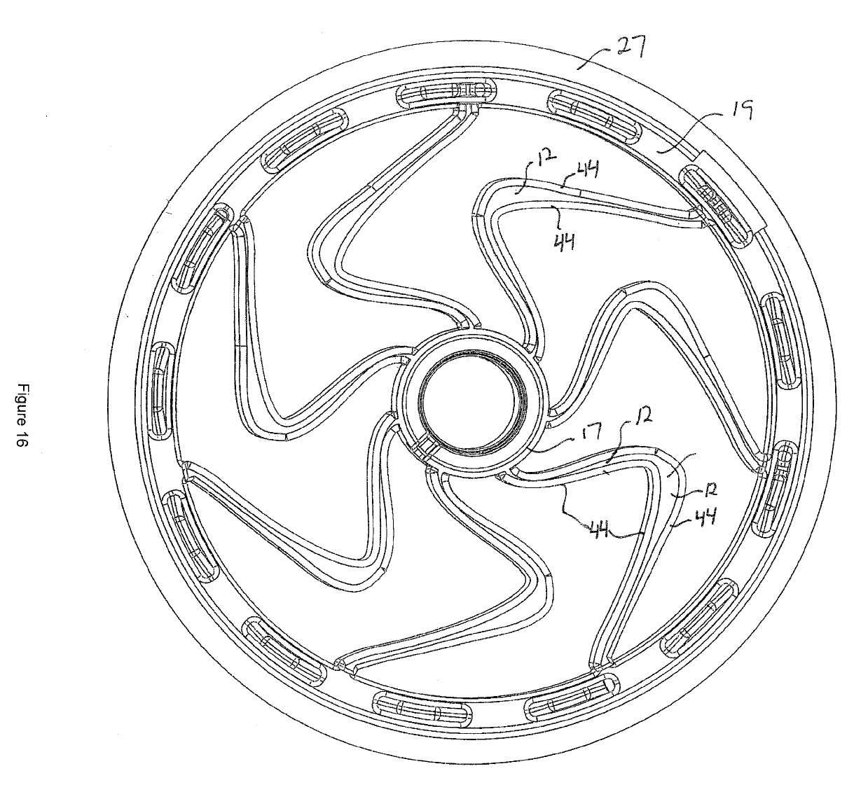

The use of alternative flexible structures in suspension 10 is contemplated. Examples of a few alternatives are shown in FIGS. 17 to 20. In FIG. 17, piston struts 60, which can be pneumatic, gas, hydraulic or spring-actuated, are disposed between hub 17 and rim 19. As will be appreciated however, struts of this nature work best when loaded in the normal direction of piston travel and do not work as well as they become oriented to become perfectly horizontal so struts may have less consistency in their spring rates as they rotate relative to the axle compared to the use of leaf springs.

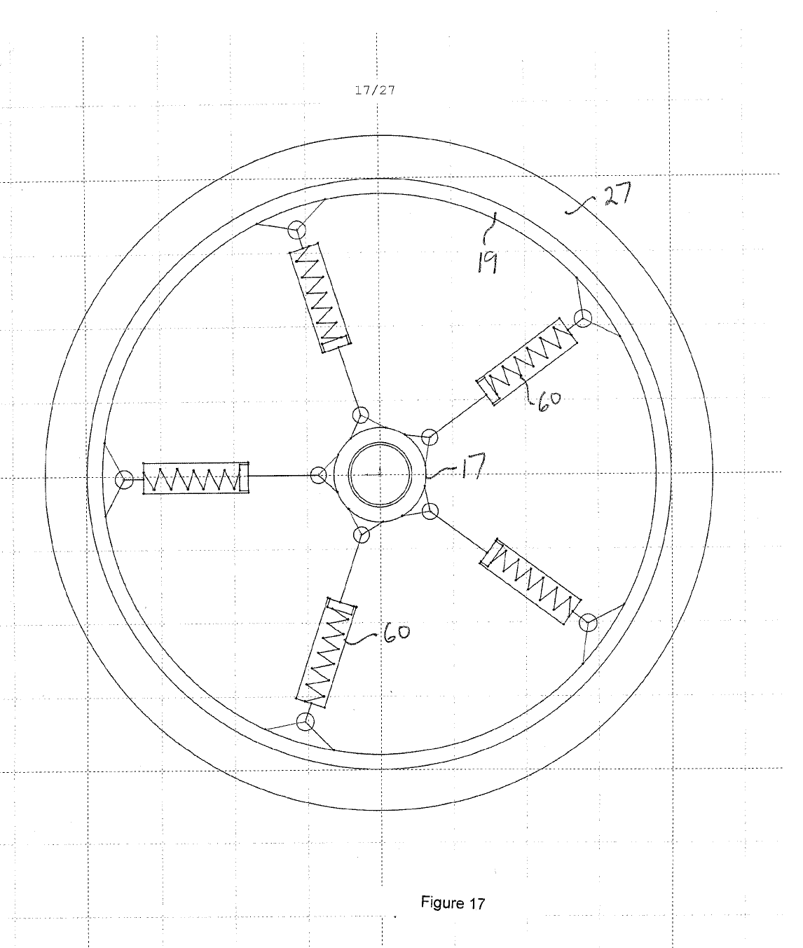

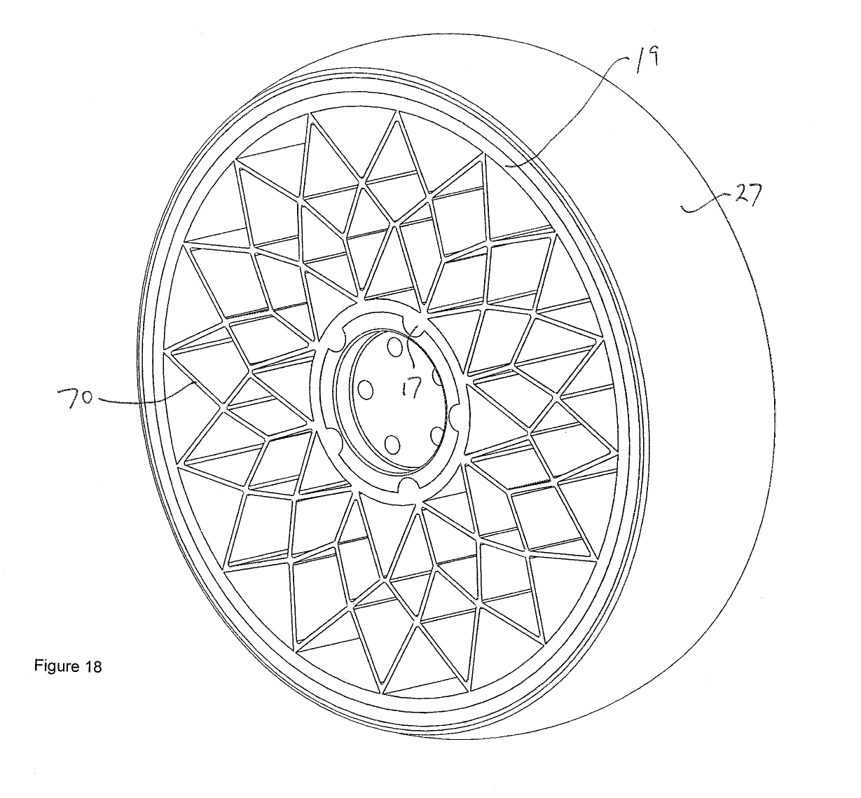

FIG. 18 illustrates the use of a flexible web 70 between rim 19 and hub 17. This is similar to the Michelin Tweel described in U.S. Pat. Nos. 6,769,465, 7,013,939 and 7,201,194. Importantly however, the Tweel is not an RPS wheel in that it lacks a rigid rim 19. The Tweel makes use of a flexible rim so that it deforms on the bottom to provide a contact patch with the ground. In an RPS wheel, this same function can be provided by laminating or otherwise locating a softer compliant tread or ground engaging layer 27 onto rim 19 as shown in FIG. 19. If preferred, layer 27 can be formed with an inner void 26 which can be filled with air or a softer resilient material to allow the use of a relatively hard or durable material for outer layer 27 while still providing enough resiliency to layer 27 as a whole to form a contact patch with the ground. If desired, a pneumatic tire can also be installed on rim 19 if the rim is shaped like the rim on a conventional pneumatic tire wheel. The Tweel, the name being a contraction of “tire and wheel”, does not provide for axle suspension in the manner of RPS. More specifically, the Tweel is not a suspension system but merely a replacement or substitute for a conventional tire.

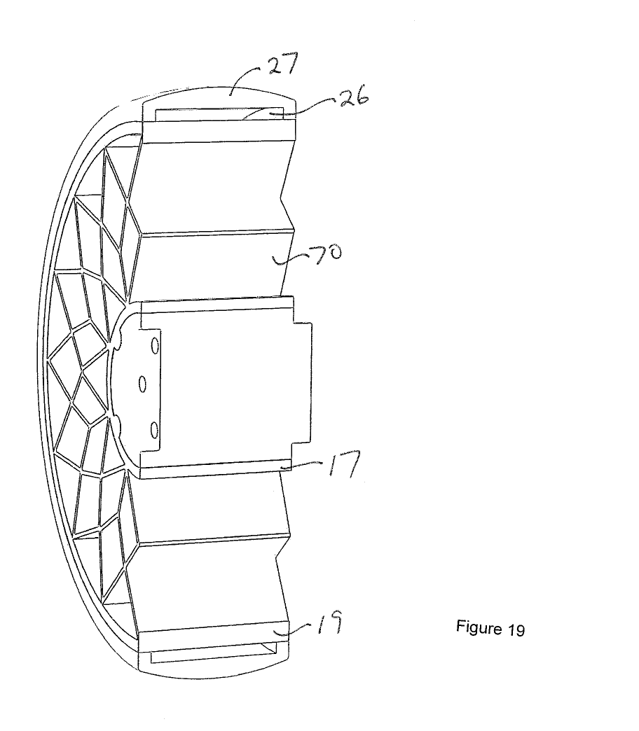

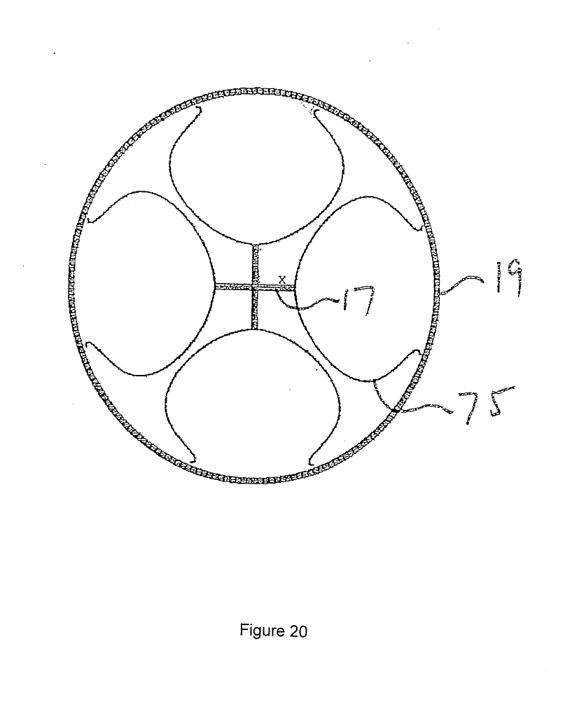

FIG. 20 schematically shows another possible flexible member for use in suspension 10 in the nature of generally C-shaped springs 75 disposed between rim 19 and hub 17. As will be appreciated by those skilled in the art, the use of other spring shapes such as round or triangular, is possible. Any spring or resilient member that performs the functions described herein is within the contemplation and scope of the present invention.

The suspensions described above are, generally speaking, best suited for use on non-powered vehicles. In powered wheels, in which hub 17 will normally be connected to an axle that delivers rotational torque to the wheel from either a source of power or a brake, it's preferable that the wheel has one less degree of freedom of movement. Specifically, it's preferable that any rotation of the hub and rim relative to one another be restrained. The suspension 10 therefore in a powered wheel ideally allows for two degrees of freedom, namely, horizontal and vertical displacement only. In other words, in powered applications, it's particularly preferred that suspension 10 provide high or even infinite rotational stiffness. Regular solid vehicle wheels possess infinite or near infinite rotational stiffness and RPS wheels should ideally have this same property.

The applicant has found that a particularly preferred means of eliminating the rotational degree of freedom between hub 17 and rim 19 is to use a parallel mechanism of flexible members as shown in FIG. 21 wherein like elements are identified using like reference numerals.

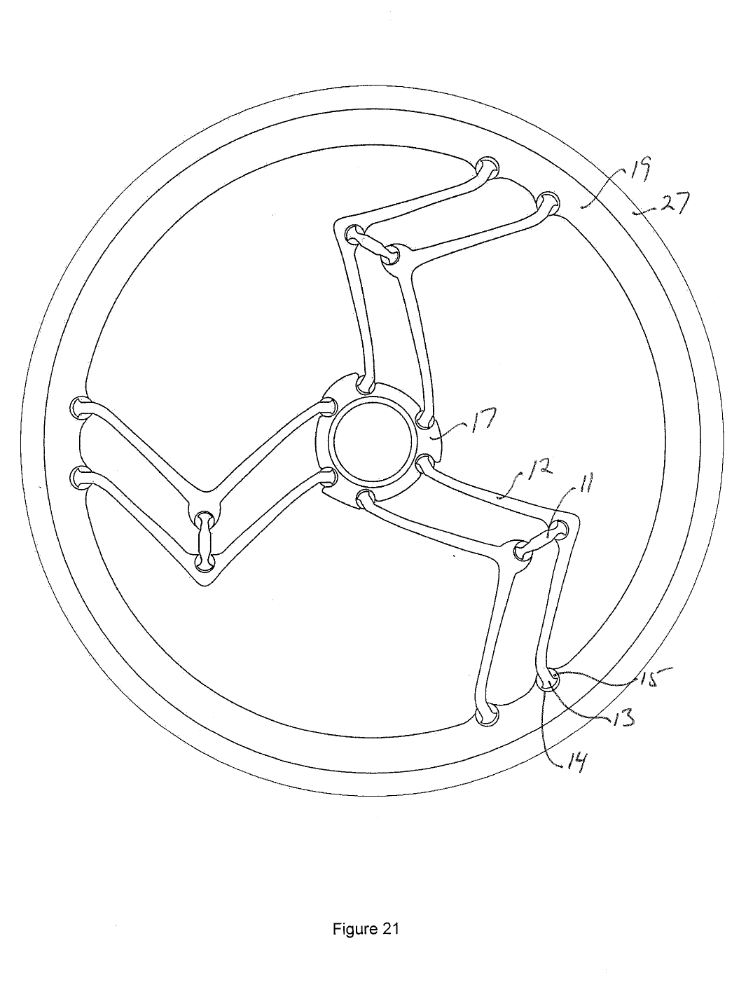

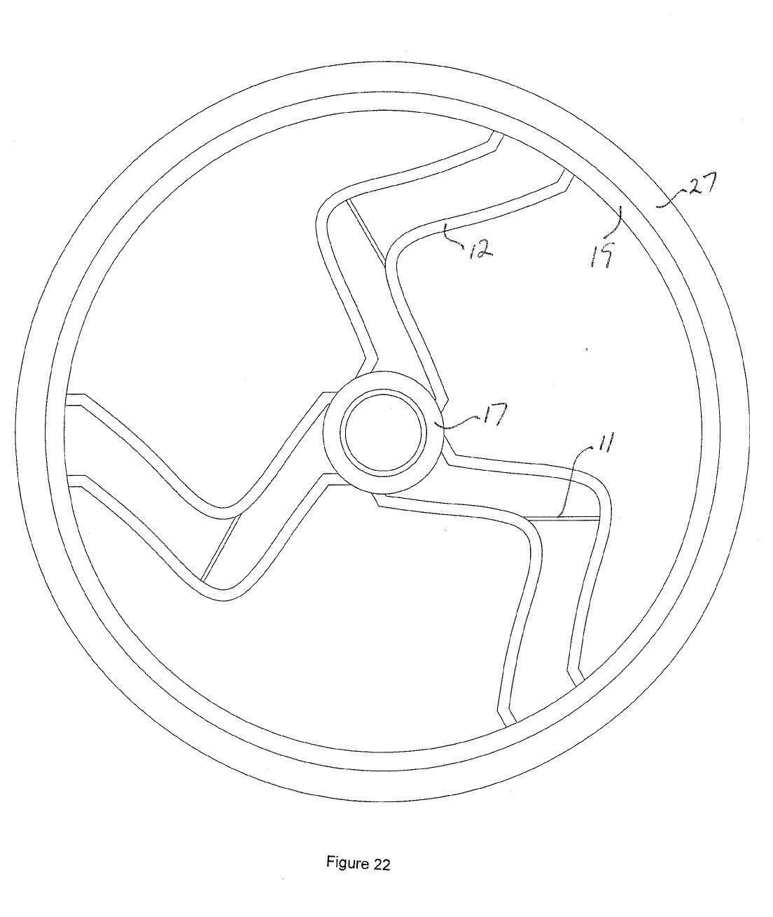

In this construction, the same basic components are present, namely hub 17, rim 19 and springs 12. The springs however are disposed in parallel pairs with each pair being linked by a cross-member 11. In the embodiment shown, cross members 11 extend orthogonally between adjacent springs but they can also extend between the two at more oblique angles as shown in FIG. 22. The actual angle for maximum rotational stiffness can be optimized for anticipated loads and applications of the wheel. The connection between the springs, rim, hub and cross-members can use the same bead 13, socket 14 and sleeve 15 construction described above in connection with the non-powered wheels.

As will be appreciated, the wheel shown in FIG. 20 is asymmetrical, meaning that its rotational stiffness might be different depending on whether the wheel is turning clockwise or counter clockwise.

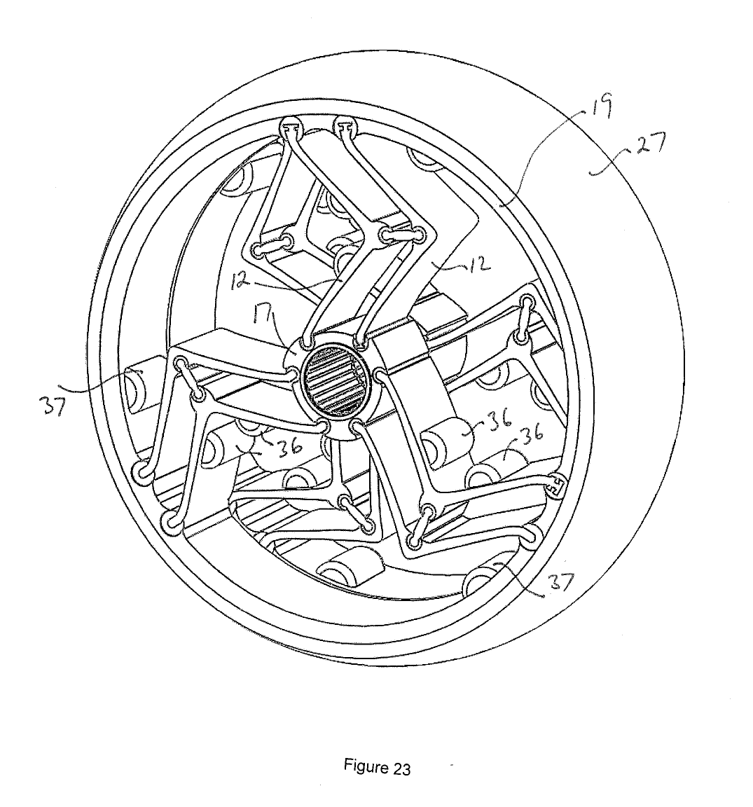

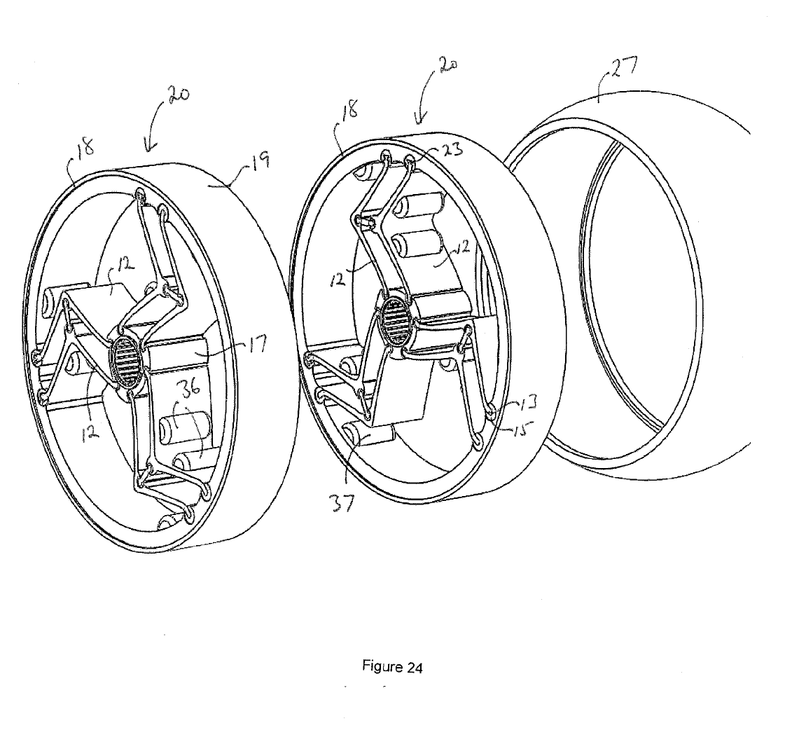

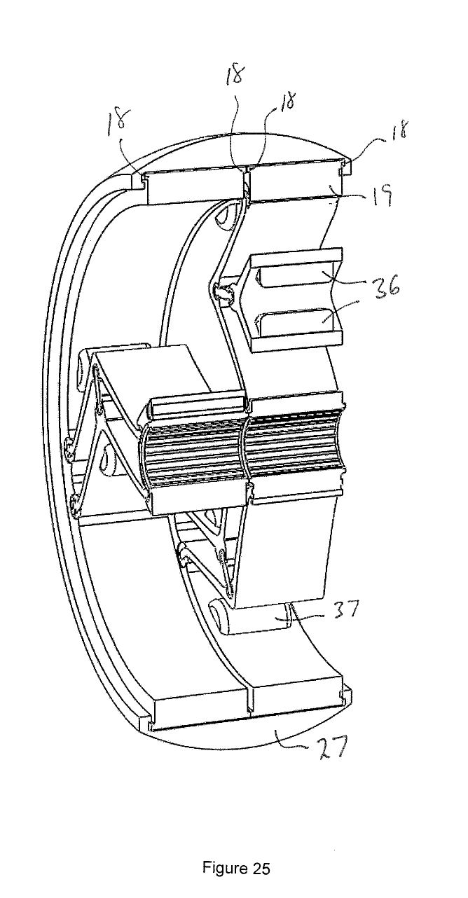

One way of countering this is to pair two wheels with their springs in side by side placement but in opposite orientations as shown in FIGS. 23 and 24. More specifically, as seen most clearly in FIG. 24, two identical wheels 20 are oriented with their springs 12 in opposite directions. The wheels can be held together, at their hubs, by means, for example, their mounting onto a common axle (not shown) and at their rims by a common encasing tread 27. As will be seen most clearly in the cross-sectional view of FIG. 25, the outer peripheral edges of rims 19 of each wheel are formed with a laterally extending flange or lip 18 that provides a convenient connection means for tread 27. Where flanges 18 meet at the center of the paired wheel, they form a block or plug against the ingress of rubber if tread 27 is injected molded onto the paired wheel.

In the embodiment shown in FIGS. 23 to 25, the wheel includes, for purposes of illustration and exemplification only, build up springs 36, bumper stops 37 and both beads 13 and barbs 23 for connection to sleeves 15.

The powered wheels can be damped using similar mechanisms to those described above in connection with the non-powered wheels. In this regard, they can be coated with rubber, filled with rubber or the area between the parallel springs can be fully or partially injected with rubber or other damping materials such as those mentioned above.

As described above, in both powered and non-powered RPS wheels, the available space between the wheel's hub and rim is used to place a series of flexible members such as springs 12. The flexible members, if in the nature of leaf springs, are a series of identical discrete elements placed inside the wheel. It's desirable to optimize the spring shape to achieve maximum wheel travel, desired stiffness and also maintain the stress level within an acceptable range for the spring material used. The shapes moreover, should be designed to avoid interference between the springs, hub and rim.

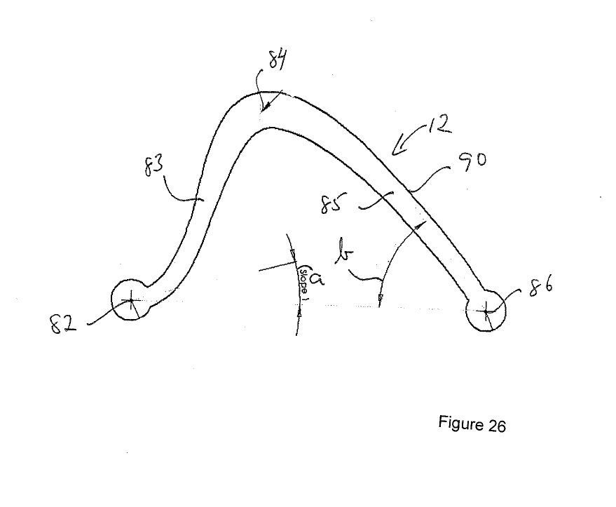

Applicant has found that a preferred shape is the spline shape 90 shown in FIG. 24. The spring shown in FIG. 26, which is optimized for a hand truck, is a spline, passed through three key points, 82, 84 and 86 with selected slopes, a and b at the ends. The section height (amplitude) and width of the spring are optimized at five locations along the spline, being key points 82, 84 and 86, a fourth point 83 located between key points 82 and 84 at the same distance from key points 82 and 84 along the spline, and a fifth point 85 placed between key points 84 and 86 with equal distances from key points 84 and 86 along the spline. The section properties of the rest of the spring can be linerally interpolated between these five points.

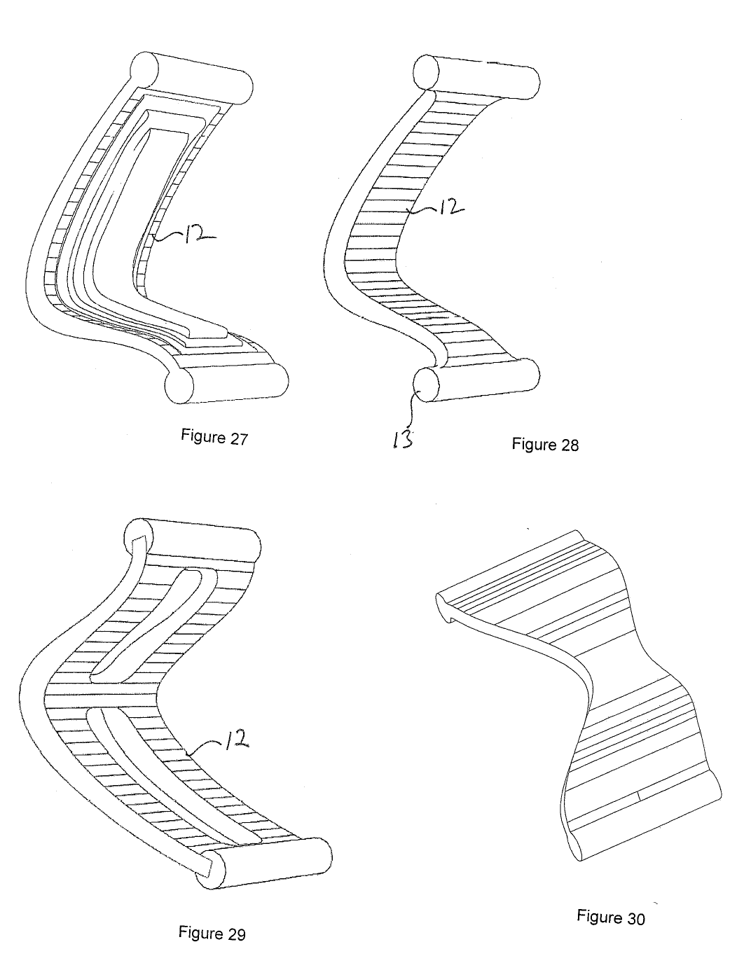

As mentioned above, leaf springs 12 will normally be roughly V-shaped when seen from the side. But the overall configuration can vary considerably depending upon the application or specified requirements. FIGS. 27 to 30 illustrate several possible configurations by way of examples only. With reference to FIG. 27, spring 12 can be laminated or layered. The spring can be narrowed in width as shown in FIG. 28 for weight saving or improved clearance. The spring can be formed with voids 4 as shown in FIG. 29 to save weight or relieve localized stress points, or it can be narrowed at the waist (or elsewhere) as shown in FIG. 30. Obviously, other configurations are possible without departing from the scope of the present invention.

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

1-31. (canceled)

32. A suspension wheel comprising:
A substantially rigid rim;
A substantially rigid hub disposed concentrically within said rim to define an annular space between the rim and the hub, said hub being adapted for connection to an axle for said wheel; and
suspension means disposed in said annular space and connected to said rim and said hub to allow said rim to move in one or both of the horizontal and vertical directions relative to said hub in response to an input to said rim.

33. The wheel of claim 32 wherein suspension means is resiliently flexible.

34. The wheel of claim 33 wherein said suspension means comprise a plurality of spaced apart flexible members extending radially between said hub and said rim.

35. The suspension of claim 34 wherein said flexible members are leaf springs.

36. The wheel of claim 35 wherein each said leaf spring has a first end for connection to said rim and a second end for connection to said hub.

37. The wheel of claim 36 wherein said first and second ends are non-revolutely connected to said rim and said hub, respectively.

38. The wheel of claim 36 wherein said first and second ends are revolutely connected to said rim and said hub, respectively.

39. The wheel of claim 36 wherein said first and second ends are semi-revolutely connected to rim and said hub, respectively.

40. The wheel of claim 39 wherein said first and second ends are semi-revolutely connected by means of, for each of said first and second ends, a socket formed in each of said rim and hub, an end portion disposed at each of said first and second ends of the spring to be received into respective one of said sockets and sized to leave an annual space between said end portion and said socket and elastomeric material placed in said annular space to retain said end portions in said sockets and to allow said first and second ends of said springs to semi-revolutely pivot relative to said rim and hub.

41. The wheel of claim 38 wherein said first and second ends are revolutely connected by means of, for each of said first and second ends, a socket respectively formed in each of said rim and hub, a cylindrical bead disposed on each of said first and second ends, said beads being rotatably received into respective ones of said sockets to form a revolute joint therebetween.

42. The wheel of claim 32 including damping means comprising, an energy absorbing material applied to said springs, said energy absorbing material being selected from the group consisting of rubber, polyurethane and thermoplastic elastomer elastomeric.

43. The wheel of claim 35 including progressive rate buildup springs disposed on said springs at selected locations to act in series with said springs to increase the spring rate of said springs under increased loading.

44. The wheel of claim 36 wherein said springs comprise pairs of said leaf springs, arranged substantially parallel to one another.

45. The wheel of claim 44 wherein the springs of each pair are connected together at a point intermediate the connection of the springs of each pair to said rim and said hub.

46. The wheel of claim 45 wherein the springs of each pair are connected together by means of a cross-member extending transversely therebetween.

47. The wheel of claim 46 wherein said cross-member is disposed at a pre-determined angle relative to the springs of each pair, said angle selected to provide optimal rotational stiffness to said wheel.

48. The wheel of claim 44 wherein the wheel includes a first set of said pairs of springs, each of said springs being generally v-shaped when seen from the side with the apexes of said v-shaped springs oriented in one of the clockwise or counter clockwise directions relative to said rim, and a second set of said pairs of springs disposed beside said first set with the apexes of said v-shaped springs oriented in the other of the clockwise or counter clockwise directions relative to said rim.

49. The wheel of claim 33 wherein said suspension means is a resiliently flexible web disposed between said hub and said rim.

50. The wheel of claim 40 wherein said end portions disposed at the first and second ends of said springs are shaped for a mechanical interlock with said elastomeric material.

51. The wheel of claim 50 wherein said end portions are barbed for said mechanical interlock.
